(19) United States
(12) Patent Application Publication
(10) Pub. No.: US 2018/0291266 A1
(43) Pub. Date: Oct. 11, 2018

(54) A CARBON QUANTUM DOT SYNTHESIZING METHOD AND ITS APPLICATION OF MODIFYING FUNCTIONAL WATER PURIFICATION MATERIAL

(71) Applicant: DALIAN UNIVERSITY OF TECHNOLOGY, Dalian City, Liaoning Province (CN)

(72) Inventors: Wei MA, Dalian City, Liaoning Province (CN); Fanqing MENG, Dalian City, Liaoning Province (CN); Liyan GUO, Dalian City, Liaoning Province (CN); Lei WU, Dalian City, Liaoning Province (CN); Shibo DUAN, Dalian City, Liaoning Province (CN); Zhen CHEN, Dalian City, Liaoning Province (CN); Shuangen YU, Dalian City, Liaoning Province (CN); Ren WANG, Dalian City, Liaoning Province (CN); Jun XU, Dalian City, Liaoning Province (CN)

(21) Appl. No.: 15/766,187

(22) PCT Filed: Feb. 24, 2017
(86) PCT No.: PCT/CN2017/074666

§ 371 Date: Apr. 5, 2018

(30) Foreign Application Priority Data
Mar. 11, 2016 (CN) 201610139530.3
Dec. 29, 2016 (CN) 201611246122.4

(51) Int. Cl. C09K 11/65; C02F 1/28

(52) U.S. Cl. CPC C09K 11/65; B82Y 20/00; C02F 1/281; C02F 1/288

(57) ABSTRACT

The present invention relates to the technology of material surface modification and the preparation adsorption new material, which involves the preparation of CQDs and the application of CQDs on modifying water purification function material. Firstly, the CQDs with rich functional groups and specific graphene structure has been prepared based on the low-cost biomass. Then, modified the traditional adsorbent by prepared CQDs under the in situ synthesis process. Secondly, synthesis the CQDs basic on the organic waste-water under low-temperature hydrothermal treatment process. Then, prepared the CQDs modified water purification material by collecting the CQDs under the flocculation process. This invention can be used in the widely used in the field of modification and preparation of functional materials, because of it not only gives a new method to synthesis low-cost and high performance water purification material, but also provide a new idea to treat high toxicity and refractory organic waste-water.

### TECHNICAL FIELD

The invention provides a method and application of carbon quantum dot preparation and its modified water purification function material, which belongs to the field of preparation of material surface modification and a kind of new water purification function materials.

### BACKGROUND

As we all know, water is the most basic human resource. While 71 percent of the earth is covered by water. However the amount of fresh water available for human to use is only about 0.7 percent of that. With the development of economy, environmental problems are becoming more and more prominent. The state of China's environment indicate that 50 percent of the environmental events in recent years have been related to water pollution, and the ensuing pollution incidents that water pollution control is urgently needed. In order to control water pollution and meet the requirements of the risk of human health and the aquatic environment, a variety of water treatment technology has been developed, including the coagulation and flocculation, catalytic oxidation, membrane filtration, biological treatment, adsorption, etc. The adsorption method is the most popular method for the treatment of pollutants in wasted water, because its advantages of thorough treatment, low pollutant residue concentration, and the regeneration of adsorbent.

At present, all kinds of absorbent material has been widely applied to water treatment, inorganic materials including ionic sieve, hydrotalcite, spinel, etc., which has a good adsorption performance and selective to the target element. The ion screen materials found by former Soviet scientist Vol 'kin showed selective adsorption of lithium ions, but the following study showed that the adsorption of lithium was small. Biomass material has large adsorption capacity and specific surface area, which has been widely applied to the purification of water quality, unmodified biomass has certain adsorption ability to the target element, which depends on the structure of the functional group in cellulose, hemicellulose, lignin and pectin. The interior of unmodified biomass is amorphous structure. Most biomass are a kind of wide-spectrum absorbent material which have selectivity to target material. Porous biomass adsorbent is a kind of activated carbon which activation by the biomass substrate. BaoyuGao (shandong university) reported a modified biomass adsorbent based on natural straw under the air activation which showed high specific surface area with good adsorption capacity. However, it's adsorption process is but a wide adsorption and was influenced by the salinity of the system. The mentioned properties directly restricts the development and application the adsorbent material. The modified adsorbent material obtained by modifying the original adsorbent material through appropriate technical modification can not only overcome the limitation of the adsorption capacity of traditional materials but also maintain its inherent advantages. Therefore, more and more technologies have been applied to the adsorption material modification including the introducing of orifices to modify its pore structure, the introducing of multi-metal skeletons, and the introducing of the crystal type and space arrangement and magnetic materials to enhance its separation efficiency. Two physicists at the university of Manchester, England Geim and Novoselov found that graphene materials also caused a strong reaction in the scientific community, promote various kinds of graphene modified composite material, make a big breakthrough in the structure and properties of the original material. Graphene composite materials have also been widely used in many fields, such as photocatalysts, biosensors, lithium-ion batteries and supercapacitors. This is greatly expand the application field of graphene composites, at the same time provide some new ideas about modifying traditional adsorbent. Studies have shown that the special properties of the graphene material depend on its special size and the crystal structure.

Carbon quantum dots as a new type of carbon material, not only has good stability and biocompatibility, but also has abundant surface functional groups and the special structure of graphene carbon group. It was widely used in light chemical, biological imaging and other fields because of the superior photoluminescence properties. However, few studies have reported its application in the modification of water quality purification function materials. What's more, the carbon source precursor of the current carbon quantum dot material is selected as the organic solvent of macromolecules and some biomass materials. There isn't any report about the application of organic wastewater direct preparation of prepare carbon quantum dots under low temperature carbonization. Besides, carbon quantum dots have good solubility in water and nano structure for its purification and extraction of demanding. At present, the carbon quantum dots in aqueous solution are extracted by dialysis and freeze-drying, those process are not only complicated and time-consuming but also need certain economic cost which is not conducive to the production and application. Coagulation technology as a traditional water purification technology is widely applied, but there was no report about the application of coagulation technology to collect carbon quantum dots material. Moreover, the flcos contains the carbon quantum dots and flocculant could be used as potentially functional water purification materials under following re-production process.

Therefore, the present invention aims to prepare of potentially functional water purification materials by introducing the biomass basic CQDs into the adsorbent synthesis process. This process can optimize the particle channels and lattice vacancies of the adsorbent and form composite modification materials with unique lattice defects and surface properties. There was no report on this modified process which can be used as new method to synthesis potentially functional composite materials. Moreover, it also gives a new method to treat organic waste-water and to achieve the carbon resources recycling. Therefore, the present invention not only gives new method to synthesis low-cost functional water purification materials, but also provides a potential method to treat organic waste-water.

### SUMMARY

The present invention aims to provide a potential water purification materials by introducing the CQDs into the adsorbent synthesizing process which is not only can solve insufficient of the raw material and technology, but also can effectively improve the adsorption performance of the adsorbent and the treatment efficiency of the organic waste-water.

### The Present Invention has the Following Technical Solution

A preparation method of a carbon quantum dot is adopted as one of two methods:

The first preparation method is as follows:

1) Raw biomass material were washed by the deionized water and then further cut into small pieces and dry at 60° C. for 24 hours. Approximately 1-100% solid-to-liquid ratio of biomass/water mixed suspension was prepared.

2) The mixture was then heated in a commercial oven at 100-200° C. for 2-10 h or at 500-2000 W microwave reaction under the condition of 10-300 min to obtain the biomass base CQDs solution with hydroxyl group and carbonyl groups.

3) The CQDs solution was filtered and dried to get the biomass base carbon quantum dots powder. The dried method should protect the fine structure and surface functional groups of biomass base carbon quantum dots.

The biomass material can be one or more than one of crops, fruits, discarded peel, straw, natural gum.

The Second Preparation Method is as Follows:

1) Add one appropriate amount of PEG-2000 to the organic waste-water and supersonic dispersion to get uniform mixed liquid.

2) The mixture was then heated in a commercial oven at 100-200° C. for 2-10 h or at 500-2000 W microwave reaction under the condition of 10-300 min to obtain the biomass base CQDs solution with hydroxyl group and carbonyl groups.

3) The CQDs solution was filtered and dried to get the biomass base carbon quantum dots powder. The dried method should protect the fine structure and surface functional groups of biomass base carbon quantum dots.

The using dried method is freeze-dried method.

A Method of Preparing the CQDs Modified Composite Adsorbent is as Follows:

Carbon quantum dot powder solutions (1-100%) were prepared by DI water. Then, the CQDs solution were used in the traditional inorganic adsorbent synthesizing process to replace the DI water and get the CQDs modified adsorbent. In this process, some Lattice defect or pore structure could be obtained by the introducing of the CQDs which are helpful to improve the adsorbent performance.

The traditional inorganic adsorbents include molecular sieves, metal oxides, montmorillonite and mullite include, which have structure or ionic memory effects.

The method of introducing CQDs includes temperature immersion, inert atmosphere, water bath, microwave or ultrasound method.

A Method of Preparing Water Purification Materials by Modified Inorganic Materials by CQDs is as Follows:

1) Add one appropriate amount of PEG-2000 to the organic waste-water and supersonic dispersion to get uniform mixed liquid.

2) The mixture was then heated in a commercial oven at 100-200° C. for 2-10 h or at 500-2000 W microwave reaction under the condition of 10-300 min to obtain the biomass base CQDs solution with hydroxyl group and carbonyl groups.

3) Add coagulant into the prepared CQDs solution and adjust the pH to 7-12; then, quickly Stirring for 1-10 min, slowly stirring for 5-30 min for 1-2 hours to get the suspension solution.

4) Filter the prepared suspension solution to obtain the CQDs modified coagulant composite solids, and then calcined the coagulant to obtain the water purification material.

The coagulant is one or more than two of iron salts, aluminum salts, and titanium salts.

The present invention has four beneficial effects: (i) the cost of the invention is low, and the source of biomass or organic waste water is chosen as the base material of carbon, without the need to add other agents to prepare the carbon quantum dots of rich oxygen-containing functional groups. (ii) the operation is simple, only domestic oven and reaction kettle can complete, don't need special requirements such as protective atmosphere, vacuum and high temperature, modification process with the method of impregnation, easy to promote and mass production. (iii) the modified of adsorbent materials, not only have good adsorption performance, but also have abundant surface functional groups to increases the selectivity of the target material, to reduce costs and improve application performance. (4) it is low-cost and energy-efficient by using coagulation process to collect CQDs and to prepare the water purification material.

### DESCRIPTION OF THE DRAWINGS

FIG. 1 is an infrared spectrogram of the carbon quantum dots that are synthesized by the invention.

FIG. 2 is an X-ray diffraction pattern of the carbon quantum dots.

FIG. 3a is a photoelectron microscope image of a carbon quantum dot in 50 nm.

FIG. 3b is a photoelectron microscope image under 10 nm for the carbon quantum dots of the invention.

FIG. 4 is a comparison curve of the adsorption performance of a biomass base carbon quantum dot modified ion sieve material and traditional ionic sieve material for lithium elements.

FIG. 5 is a comparison curve of the adsorption performance of the boron element with the modified water-talc material and the traditional water-talc material.

FIG. 6a is the X-ray photoelectron diffraction spectrum of carbon quantum dot modified titanium dioxide functional materials obtained by the invention of coagulation recovery quantum dots.

FIG. 6b is the X-ray photoelectron diffraction spectrum of O elements in the functional materials of the carbon quantum dots modified by the invention of coagulation recovery quantum dots.

FIG. 6c is the X-ray photoelectron diffraction spectra of Ti elements in the functional materials of the carbon quantum dots modified by the invention of coagulation recovery quantum dots.

FIG. 6d is the X-ray photoelectron diffraction spectra of Ti elements in the functional materials of the carbon quantum dots modified by the invention of coagulation recovery quantum dots.

FIG. 7 is the degradation curve of acrylonitrile by the modification of titanium dioxide with a carbon quantum dot.

### DETAILED DESCRIPTION

The following combination of the attached drawings and technical scheme further explains the concrete implementation of the invention.

### Implementation Example 1

1) The gum were washed by the deionized water and then further cut into small pieces and dry at 60° C. for 24 hours. Approximately 10% solid-to-liquid ratio of gum/water mixed suspension was prepared.

2) put the gum clouding solution put in 50 mL polyethylene lining of reaction kettle, then heated in a commercial oven at 150° C. for 5 h to obtain the gum base CQDs solution.

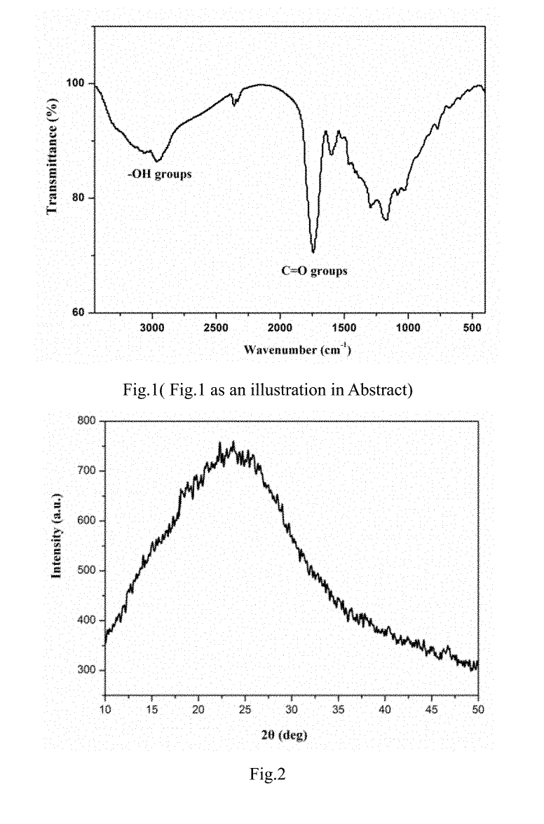

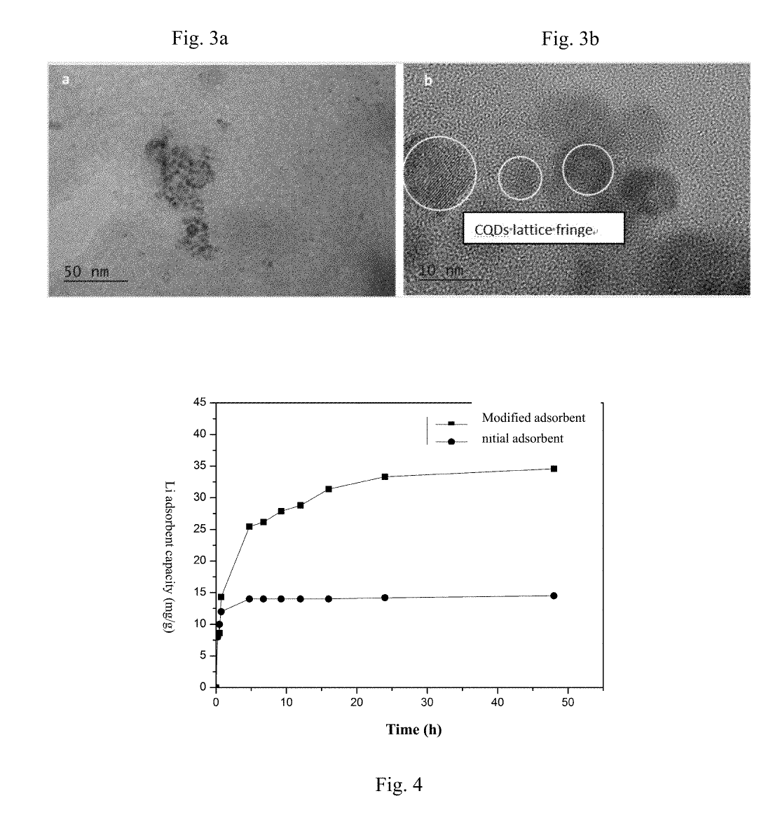

3) The prepared CQDs solution was filtered by the 25 microns filters to remove unreacted rubber particle and carbon particles to get the biomass base CQDs powder. Then freeze-dried to get CQDs powder product. The structure information of the prepared CQDs was shown in FIG. 1-3.

4) Add one appropriate amount of CQDs powder to the DI water and supersonic dispersion to get 1-10% CQDs solution.

5) Dissolve 11.88 g of reagent grade MnCl₂.H₂O powder in prepared CQDs solution with CQDs liquor to 200 mL to get the solution A.

6) Dissolve 12.59 g of reagent grade LiOH.H₂O powder in prepared CQDs solution with CQDs liquor to 400 mL to get the solution B.

7) In the mixing condition, the solution B is slowly added to a smooth solution of A, and a quick stirring of over 500 rpm for 30 min to get the brown suspension.

8) After a quick stirring of over 500 rpm, add 30% of the H₂O₂ drops of 15 mL to the prepared brown suspension, and after the drop, continue to stir 2h for more than 500 rpm, and get the brown and black suspension.

9) The black suspension was filtered and washed by DI water to get the black filter cake.

10) wash the filter cake with deionized water for 2-3 times and dried at 60-120° C. to obtain the CQDs modified lithium ionic sieve adsorbent material.

### Implementation Example 2

1) Add 2 mL reagent grade PEG-2000 to 15 mL organic wastewater, and ultrasonic dispersing 10 min to obtain uniform liquid;

2) Put the gum clouding solution put in 50 mL polyethylene lining of reaction kettle, then heated in a commercial oven at 150° C. for 5 h to obtain the gum base CQDs solution.

3) The prepared CQDs solution was filtered by the 25 microns filters to remove unreacted rubber particle and carbon particles to get the biomass base CQDs powder. Then freeze-dried to get CQDs powder product. The structure information of the prepared CQDs was shown in FIG. 1-3.

4) Add one appropriate amount of CQDs powder to the DI water and supersonic dispersion to get 5% CQDs solution.

5) Dissolve 18.94 g of reagent grade MgSO₄.7H₂O and 8.79 g Al₂(SO₄)₃.18H₂O powder in prepared CQDs solution with CQDs liquor to 200 mL to get the solution C.

6) Dissolve 8.41 g of reagent grade NaCO₃ and 33.53 g of reagent grade NaOH powder into DI water to get the solution D.

7) In the mixing condition, the solution D is slowly added to a smooth solution of C, and a quick stirring of over 500 rpm for 30 min to get the white suspension.

8) Make the prepared white suspension under 80° C. microwave coprecipitation for 20 min, then filtered to get white filter cake.

9) wash the filter cake with deionized water for 2-3 times and dried at 80° C. to obtain the CQDs modified LDHs adsorbent material.

### Implementation Example 3

The adsorption of lithium by using CQDs modified ion sieve adsorbent material:

1) Dissolve KCl 36.9 g, NaCl 480 g, MgCl₂.6H₂O 153 g, CaCl₂ 0.420 g, LiCl 3.01 g and H₃BO₃ 19.1 g into 2 LDI water to get the simulated salt lake water solution.

2) Add 0.1 g of the prepared CQDs modified ion sieve adsorbent material and traditional ion sieve adsorbent material into the 100 mL simulated salt lake water solution, respectively. Then, stirred for some time and measured the concentration of lithium ions.

3) The adsorption performance of the two adsorbents were shown in FIG. 4.

### Implementation Example 4

The adsorption of boron by using CQDs modified LDHs material:

1) Dissolve 20 mg of reagent grade H₃BO₃ powder into 1 L DI water to get the boron solution.

2) Add the proper amount of NaOH to adjust the solution pH to 7-8.

3) Add 200 mg of the prepared CQDs modified LDHs material and traditional LDHs adsorbent material into the 1 L prepared boron solution, respectively. Then, stirred for some time and measured the concentration of lithium ions.

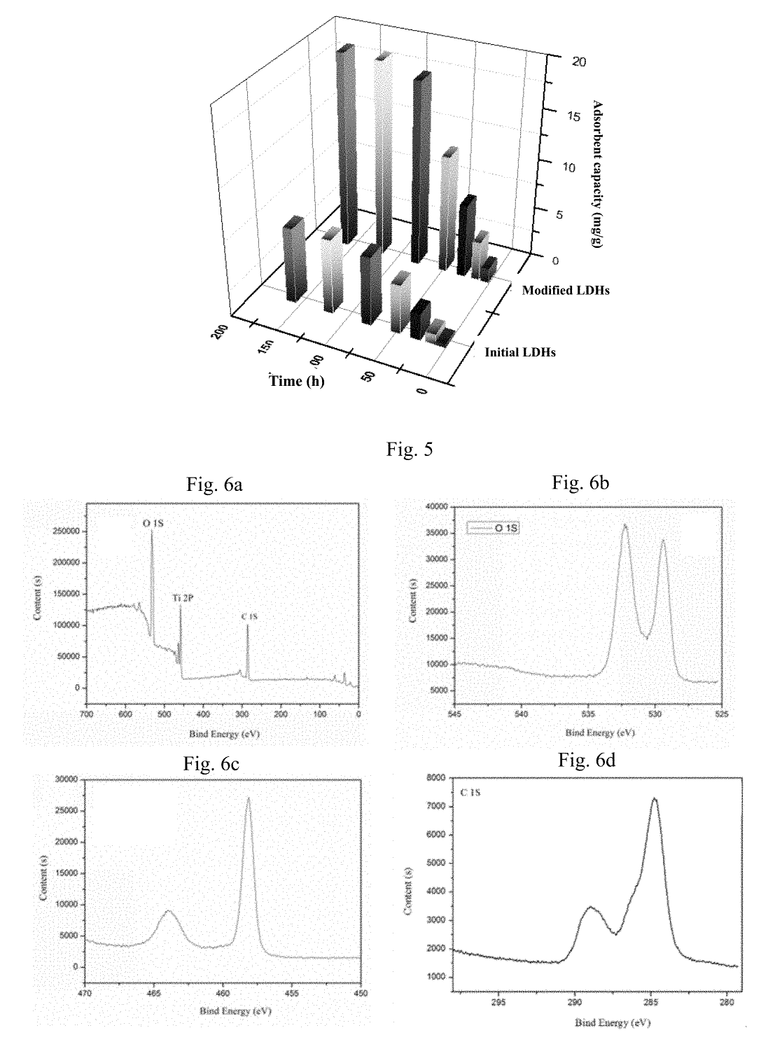

4) The adsorption performance of the two adsorbents on boron were shown in FIG. 5.

### Implementation Example 5

Using titanium coagulation collect CQDs to prepare functional water purification material.

1) Add one appropriate amount of titanium sulfate to the DI water to get the 2M titanium salt coagulant solution.

2) Add 2 ml of the prepared titanium salt coagulant to the CQDs solution (from step 2), stirring well.

3) adjust PH of the mixture solution to 8, and stir quickly for 5 min;

4) then, slow stirring for 20 min, sit for 30 min.

5) Filtered the mix solution and dried the filtercake at 100° C. to get the CQDs modified titanium oxide A.

6) calcine the CQDs modified titanium oxide A at 450° C. for 2 h to get modified water purification material B.

7) add 20 mg water purification material B the water purifier powder into 100 mL acrylonitrile solution (20 mg/L), uv lighting 2 h, and determination of the remaining acrylonitrile concentration.

8) the X-ray photoelectron diffraction spectra of the modified water purification B are shown in FIG. 6;

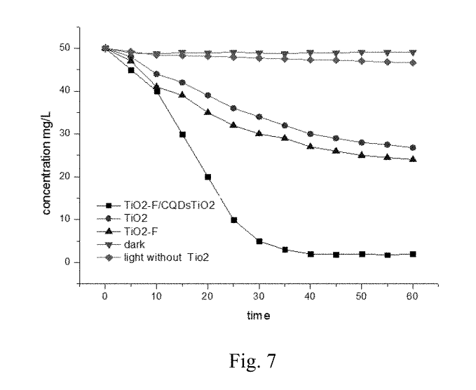

9) the concentration of acrylonitrileis shown in FIG. 7.

1. A preparation method of a carbon quantum dot, comprising steps of:
1) washing raw biomass material by deionized water and then further cutting the raw biomass material into small pieces and drying the raw biomass material at 60° C. for 24 hours; preparing 1-100% solid-to-liquid ratio of biomass/water mixed suspension;
2) heating the mixed suspension at 100-200° C. for 2-10 hours to obtain biomass base CQDs (Carbon Quantum Dots) solution with hydroxyl group and carbonyl groups; and
3) filtering and drying the biomass base CQDs solution to get biomass base carbon quantum dots powder, so as to protect fine structure and surface functional groups of the biomass base carbon quantum dots.

2. A preparation method of a carbon quantum, comprising steps of:
1) adding amount of PEG-2000 to organic waste-water and supersonic dispersion to get uniform mixed liquid;
2) heating the uniform mixed liquid at 100-200° C. for 2-10 hours or at 500-2000 W microwave reaction under a condition of 10-300 minuets to obtain biomass base CQDs (Carbon Quantum Dots) solution with hydroxyl group and carbonyl groups; and
3) filtering and drying the biomass base CQDs solution to get biomass base carbon quantum dots powder, so as to protect fine structure and surface functional groups of the biomass base carbon quantum dots.

3. The preparation method of claim 1, wherein the raw biomass material is one or more than one of crops, fruits, discarded peel, straw, and natural gum.

4. The preparation method of claim 1, wherein drying the biomass base CQDs solution is via a freeze-dried method.

5. A method of preparing adsorbent by using carbon quantum dots to prepare inorganic materials, comprising steps of:
preparing carbon quantum dots (CQDs) solution (1-100% of solid-to-liquid ratio) by DI water (deionized water); and
applying the CQDs solution in an inorganic adsorbent synthesizing process to replace the DI water and get CQDs modified adsorbent;
whereby lattice defect or pore structure are obtained by introducing the biomass base CQDs solution which is helpful to improve adsorbent performance of the CQDs modified adsorbent.

6. The preparation method of claim 1, further comprising a step of preparing adsorbent by using carbon quantum dots to prepare the inorganic materials, comprising:
preparing carbon quantum dot powder solutions (1-100% of solid-to-liquid ratio) by DI water (deionized water);
applying the biomass base CQDs solution in an inorganic adsorbent synthesizing process to replace the DI water and get CQDs modified adsorbent;
whereby lattice defect or pore structure are obtained by introducing the biomass base CQDs solution which is helpful to improve adsorbent performance of the CQDs modified adsorbent.

7. The method of claim 5, wherein inorganic adsorbents in the inorganic adsorbent synthesizing process include molecular sieves, metal oxides, montmorillonite and mullite include, which have structure or ionic memory effects; wherein introducing biomass base CQDs solution is applied via temperature immersion, inert atmosphere, water bath, microwave or ultrasound method.

8. The method of claim 6, wherein inorganic adsorbents in the inorganic adsorbent synthesizing process include molecular sieves, metal oxides, montmorillonite and mullite include, which have structure or ionic memory effects; wherein introducing biomass base CQDs solution is applied via temperature immersion, inert atmosphere, water bath, microwave or ultrasound method.

9. A method of preparing water purification materials by modified inorganic materials by CQDs (carbon quantum dots), comprising steps of:
1) adding amount of PEG-2000 to organic waste-water and supersonic dispersion to get uniform mixed liquid;
2) heating the uniform mixed liquid at 100-200° C. for 2-10 hours or at 500-2000 W microwave reaction under the condition of 10-300 minutes to obtain biomass base CQDs solution with hydroxyl group and carbonyl groups;
3) adding coagulant into the biomass base CQDs solution and adjust pH of the biomass base CQDs solution to 7-12; quickly stirring the biomass base CQDs solution for 1 to 10 minutes, and then slowly stirring the biomass base CQDs solution for 5 to 30 minutes to get a suspension solution; and
4) filtering the suspension solution to obtain CQDs modified coagulant composite solids, and then calcining the CQDs modified coagulant composite solids to obtain water purification material.

10. The method of claim 9, wherein the CQDs modified coagulant composite solids is one or more than two of iron salts, aluminum salts, and titanium salts.
